(19) United States
(12) Patent Application Publication
(10) Pub. No.: US 2014/0362428 A1
(43) Pub. Date: Dec. 11, 2014

(54) METHOD AND DEVICE FOR ACTIVATING PHOTOCHROMIC MATERIALS WITHIN A VEHICLE

(71) Applicant: Nelson Gee-Con Chen, Knoxville, TN (US)

(72) Inventor: Nelson Gee-Con Chen, Knoxville, TN (US)

(21) Appl. No.: 13/911,964

(22) Filed: Jun. 6, 2013

(51) Int. Cl. G02F 1/01

(52) U.S. Cl. CPC G02F 1/0126
USPC 359/244

(57) ABSTRACT

The present invention relates to a device and method of reversibly activating photochromic materials within an enclosed vehicle using one or more ultraviolet (UV) sources located within the interior of a vehicle. Upon activation, such UV sources cause the photochromic materials to darken; upon deactivation, the photochromic materials revert to their clear state. The photochromic materials may form part of a pair of eyeglasses (10) containing photochromic lenses, thereby enabling their use as sunglasses within an enclosed vehicle. UV sources may be aimed at the photochromic target and may be automatically modulated using a photosensor in response to changing ambient light conditions. UV sources may be positioned in differing locations within the vehicle. A variety of different UV sources may be used.

### BACKGROUND

### Prior Art

The following is a tabulation of some prior art that presently appears relevant:

U.S. Patents

| Patent Number | Kind Code | Issue Date | Patentee |
|---|---|---|---|
| 4,720,356 | A | 1988 Jan. 19 | Chu |
| 5,238,981 | A | 1993 Aug. 24 | Knowles |
| 5,581,090 | A | 1996 Dec. 03 | Goudjil |
| 5,873,621 | A | 1999 Feb. 23 | Kuighadush and Neko |
| 6,536,828 | B2 | 2003 Mar. 25 | Love and Love |
| 7,044,614 | B2 | 2006 May 16 | Levy, Gray, and Nilsen |
| 7,798,659 | B2 | 2010 Sep. 21 | Englander |

### NONPATENT LITERATURE DOCUMENTS

Eppig T, Speck A, Gillner M, Nagengast D, Langenbucher A. Photochromic dynamics of ophthalmic lenses. App. Opt 2012; 51(2): 133-138.

The development of photochromic lenses has enabled individuals who normally wear corrective eyeglasses to wear a single pair of glasses that automatically darken when exposed to sunlight and fade to clear indoors, avoiding the need for a separate pair of sunglasses. Having been developed since the 1960s for glass and the 1990s for plastic, these lenses are convenient for the wearer. The lenses incorporate a photochromic material that reacts upon exposure to ultraviolet light (UV). The reaction causes the lenses to darken. Upon the removal of UV under ambient conditions, the material reverts to its clear state, causing the lenses to revert to clear. This darkening and reversion to clear of the lenses is defined as reversible darkening. A key limitation of eyeglasses incorporating photochromic lenses though is their inability to activate within enclosed vehicles such as automobiles and trucks. Due to windshield absorption of the UV portion of sunlight, photochromic lenses typically do not darken within an enclosed vehicle as documented by Eppig and coworkers. Attempts have been made to circumvent this problem through the development of specialized lenses that react to the blue and violet portions of the visible spectrum such as Drivewear (as developed by Transitions Optical, Inc.) These lenses adjust to variations in brightness even within an enclosed vehicle. However, such lenses are never completely clear and therefore are inappropriate for indoor and nighttime use. This limitation means that the goal of avoiding the need for a second pair of eyeglasses remains unfulfilled.

Other attempts to shield vehicle occupants from bright sunlight include visors and various tinting schemes. Visors attached to the vehicle ceiling block portions of the field of view. Such can be detrimental to the driver. Traditional tinted glass does not adjust to changing light conditions. Therefore, it is not used to cover the entire front windshield. Goudjil in U.S. Pat. No. 5,581,090 describes using a photochromic film to cover the upper edge of a windshield. Knowles in U.S. Pat. No. 5,238,981 describes a series of photochromic compounds that could be incorporated into lenses, face shields, goggles, visors, windows, automotive windshields, aircraft and automotive transparencies, plastic films and sheets, textiles and coatings. Kuighadush and Neko in U.S. Pat. No. 5,873,621 describe a mechanically raised and lowered visor panel with the option of incorporating a photochromic compound. A scheme combining several window tints on a car with photochromic glass was described by Love and Love (U.S. Pat. No. 6,536,828) to reduce glare and excessive light within a vehicle. However, in addition to the cost of initially incorporating such materials into large surfaces, such approaches also suffer from fatigue of photochromic compounds. Chemical stabilizers such as those described by Chu in U.S. Pat. No. 4,720,356 slow the fatigue of these compounds, but fatigue eventually occurs nonetheless. By requiring the covering of large surfaces with photochromic material, and thereby necessitating the replacement of the photochromic surfaces upon their suffering fatigue, replacement costs are also substantial.

The incorporation of an UV source within a single device containing photochromic materials has been previously described by Levy, Gray, and Nilsen in U.S. Pat. No. 7,044,614, where the photochromic material is reversibly activated and deactivated by the source. The photochromic material can be used for aesthetic or utilitarian purposes. Such a UV source requires a source of power in order to activate, and requires that the UV source be part of the device. U.S. Pat. No. 7,798,659 by Englander describes a vehicle mirror with an incorporated UV source for activating a built-in photochromic layer in order to have the mirror adapt to changing sunlight intensity. The adaptations are limited to the mirror itself and do not cover excessive light coming from any other surfaces or sources such as the road or oncoming traffic. No device or technique currently darkens conventional eyeglasses containing photochromic lenses, which otherwise function like conventional sunglasses upon sunlight exposure, while the wearer is located within an enclosed vehicle. Especially when the wearer is a vehicle operator, reducing the light intensity when faced with direct sunlight is especially desired for both comfort and safety.

### SUMMARY

It is an object of the present invention to provide a method to darken reversibly conventional photochromic eyeglasses within an enclosed vehicle such as an automobile or truck. Another object of the present invention is to provide a device using such a method. The method involves a user-switchable source of UV located within the vehicle. When switched on, the UV causes the lenses to darken. Switched off, regular bleaching causes the lenses to revert to clear. Some embodiments specifically aim UV light toward the photochromic lenses of the vehicle operator. Embodiments could also use photosensors to modulate automatically the level of darkening of lenses based upon levels of ambient sunlight through modulating the intensity of the generated UV light. UV light in the UV-A range, as defined by environmental photobiologists as light having wavelengths between 320 and 400 nm, is used to activate lenses at levels less than that found in natural sunlight. Said light may be generated through a variety of sources: fluorescent tubes, light-emitting diodes (LEDs), and incandescent or mercury lamps may all be used together or separately in various embodiments of the invention. Embodiments may have UV sources optimized by combining different emitted wavelengths for maximal lens activation depending on the photochromic compounds present.

### ADVANTAGES

Two advantages of one or more aspects are as follows: first, eyeglasses incorporating regular photochromic lenses suitable for everyday wear retain their function even within an enclosed vehicle. Second, the activation device is independent of the eyeglasses, so there are no issues with additional weight or bulk for the wearer. Other advantages of one or more aspects will be apparent from a consideration of the drawings and ensuing description.

### DRAWINGS

### Figures

In the drawings, closely related figures have the same number but different alphabetic suffixes.

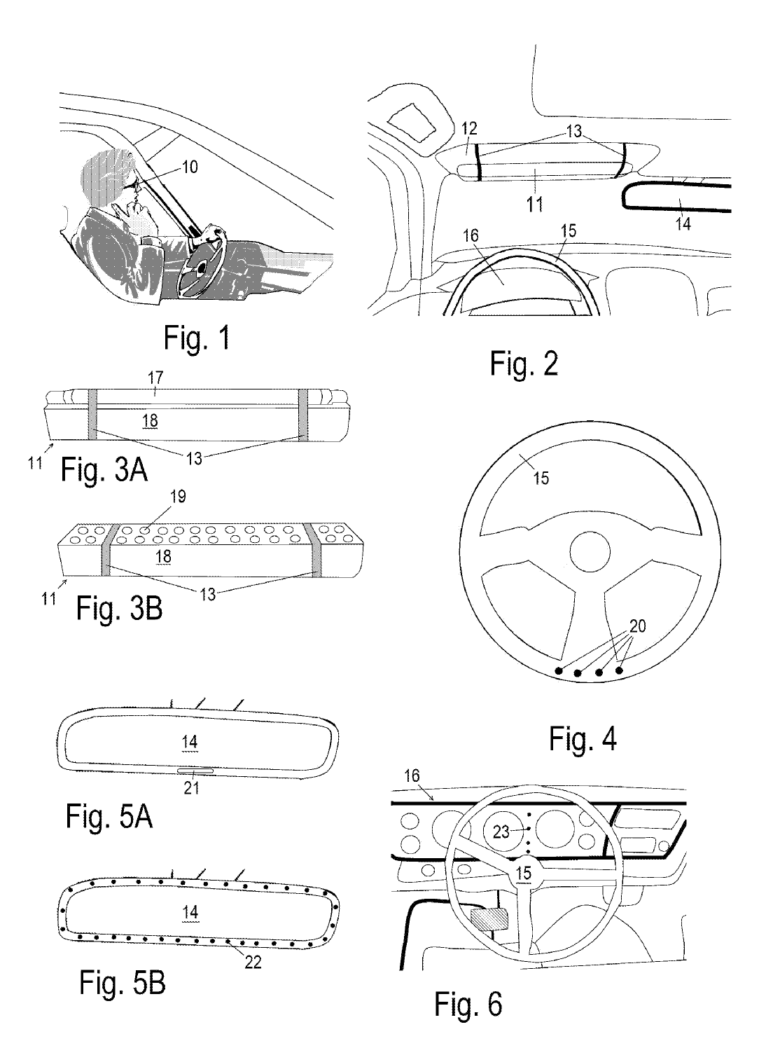

FIG. 1 shows an overview of the invention, where a UV source located within an enclosed vehicle darkens eyeglasses containing photochromic lenses.

FIG. 2 shows an overview of several possible embodiments and their location from the perspective of the vehicle operator.

FIGS. 3A and 3B show details of two embodiments using different UV sources that are visor-mounted.

FIG. 4 shows details of a third embodiment with UV sources attached or embedded within a steering wheel.

FIGS. 5A and 5B show a fourth and fifth embodiment with UV sources attached or embedded within a rear-view mirror.

FIG. 6 shows a sixth embodiment with UV sources attached or embedded in a vehicle dashboard.

### REFERENCE NUMERALS

10 Eyeglasses containing photochromic lenses
11 Device attached to visor
12 Vehicle visor
13 Attachment straps holding device to vehicle visor
14 Rear-view mirror
15 Vehicle steering wheel
16 Vehicle dashboard
17 UV emitting fluorescent tube
18 Container holding electronics components driving UV sources
19 UV LED (light-emitting diode)/mercury bulb/incandescent bulb matrix
20 UV LED/mercury bulb/incandescent bulb matrix
21 Mercury bulb
22 UV LED matrix
23 UV LED matrix

### DETAILED DESCRIPTION

### FIGS. 1-2

### Overview

A vehicle operator in an enclosed vehicle is depicted in FIG. 1. Eyeglasses containing photochromic lenses (10) are worn. Embodiments of the invention use various sources of UV-A located within said enclosed vehicle in order to darken the photochromic lenses as desired. The UV generated may be aimed at said eyeglasses and vicinity, or alternatively may be allowed to cover more of the vehicle compartment. Possible locations within the vehicle compartment for several embodiments are shown in FIG. 2. The device (11) with enclosed driving electronics may be attached to a visor (12) using straps (13) or other means of attachment. Alternatively, sources of UV may be integrated into a rear-view mirror assembly (14), steering wheel (15), or dashboard (16). Regardless of the location of the UV source, the source may be switched on or off through the use of a switch, or alternatively adjusted (dimmed) automatically through the use of a photosensor in order to darken the photochromic lenses (10) in response to the level of visible light present.

### FIGS. 3A-3B

### One Embodiment

One embodiment is a visor-mounted device (11) that is secured with straps (13) or alternative means. The UV source can be a UV emitting fluorescent tube (17), or an array of LEDs or other UV light sources (19) embedded or mounted to a container (18). The electronics required to drive said UV sources are contained within said container. Electricity to power the UV source may be provided through enclosed batteries or an external electrical cord (not shown) connected to the vehicle electrical system. A standard electrical switch (not shown) is used to activate and deactivate the device as desired. This embodiment may be built into the visor or be an aftermarket part.

### FIG. 4

### Second Embodiment

A second embodiment has UV sources mounted into the vehicle steering wheel (15). The UV sources may be formed into an array (20). Driving circuitry and related wiring are embedded within the steering wheel. Electricity is supplied from the electrical system of the vehicle through wires embedded within the steering wheel. A standard electrical switch activates and deactivates the device as desired. Alternatively, the UV sources can be embedded into a wrap that covers the steering wheel, with electrical power supplied through an external cable (not shown) or embedded battery pack. A switch is used to activate and deactivate the sources as desired. The wrap can be part of the vehicle or be an aftermarket add-on.

### FIG. 5A-5B

### Third Embodiment

A third embodiment has UV sources embedded within or mounted upon the rim of a vehicle interior rear-view mirror (14). The sources can be mercury bulbs (21) or an array of LEDs (22). The driving electronics for this embodiment are built into the vehicle, along with an electrical switch to activate and deactivate the sources as desired. Electrical power is supplied through the vehicle electrical system through embedded wires.

### FIG. 6

### Fourth Embodiment

A fourth embodiment has the UV sources located at the dashboard (16) behind the steering wheel (15) of the vehicle. The UV sources may be present in an array (23) or be present singularly. The electrical circuitry for driving the sources is integrated within the dashboard. A standard switch (not shown) activates and deactivates the UV sources as desired. Any material covering the dashboard is transparent to UV light.

### Operation

The device is switched on by the user whenever darkening of photochromic lens containing eyeglasses is desired. Upon being switched on, the device emits UV light, causing the photochromic lenses to darken. The UV intensity received at the eyeglasses is kept at levels less than that found in natural sunlight. When switched off, the lack of UV causes the lenses to revert to the clear state. During device installation, the UV sources may optionally be aimed in the general direction of the eyeglasses (10).

### General Considerations

The embodiments described all may have their UV output aimed at the eyeglasses containing photochromic lenses (10). Wood's glass or functionally equivalent filters may be used to cover the sources in order to permit UV to be emitted, while further reducing any visibility of the UV sources. The sources already have limited visibility due to their emission being mostly in the UV rather than visible range. In addition, the device is intended to be activated under strong ambient light conditions; therefore, whatever minimal visibility of the UV sources would be inconsequential. The embodiments may also contain an indicator light notifying the user of its activation. The switches described may all be connected to a dimmer circuit and a photosensor in order to adjust automatically the UV intensity in response to changing ambient light conditions.

### CONCLUSIONS, RAMIFICATIONS, AND SCOPE

Accordingly, the reader will see that this method and device allows one to use regular photochromic lens containing eyeglasses as a pair of sunglasses within an enclosed vehicle. In addition, full lens activation corresponding to its exposure to direct sunlight is achievable. Such activation is especially valuable for a vehicle operator travelling toward the direction of the sun. The device may be readily integrated into a vehicle, or installed as an aftermarket add-on. By switching the device on or off, the photochromic lens may be darkened or lightened as desired by the user. A dimmer circuit and photosensor allows automated lens adjustment.

Although the specification contains many specifics, they should not be construed as limiting the scope of the embodiments. Rather, they provide illustrations of several embodiments. Thus the scope of the embodiments should be determined by the appended claims and their legal equivalents, rather than by the examples given.

I claim:

1. A method of reversibly activating photochromic materials as desired within an enclosed vehicle, not forming part of said vehicle, comprising of the steps of:
switching on a UV source located within said vehicle,
thereby generating UV light within said vehicle,
exposing said photochromic materials to said UV light present within said vehicle,
whereby said UV light causes said photochromic materials to darken, and subsequently
switching off said source of UV light,
whereby bleaching causes said photochromic materials to revert to their clear state.

2. The method of claim 1 wherein said photochromic materials form part of a pair of eyeglasses.

3. The method of claim 1 wherein said UV sources are aimed at said photochromic materials.

4. The method of claim 1 wherein said source of UV light generates UV light with a wavelength between 320 to 400 nanometers.

5. The method of claim 1 wherein said source of UV light is one or more light-emitting diodes, incandescent bulbs, fluorescent tubes, or mercury lamps.

6. The method of claim 1 wherein said source of UV light is combined with one or more additional sources of UV light of differing wavelengths.

7. The method of claim 6 wherein said sources of UV light produces an irradiance less than that produced with natural sunlight.

8. The method of claim 1 wherein said source of UV light produces an irradiance less than that produced with natural sunlight.

9. The method of claim 1 wherein said switching occurs automatically through the use of a photosensor modulating said UV source output in response to ambient light conditions.

10. A device, comprising:
One or more sources of UV light embedded or installed within an enclosed vehicle,
whereby said sources reversibly darken photochromic materials located within said vehicle through the activation and deactivation of said sources of UV light.

11. The device of claim 10 wherein the photochromic materials form part of a pair of eyeglasses.

12. The device of claim 10 wherein one source of UV light is one or more light-emitting diodes, incandescent bulbs, fluorescent tubes, or mercury lamps.

13. The device of claim 10 wherein said sources of UV light emit UV with wavelengths between 320 and 400 nm.

14. The device of claim 10 wherein said sources of UV light are attached to a visor of said vehicle.

15. The device of claim 10 wherein said sources of UV light are attached to or alternatively are integrated into a steering wheel of said vehicle.

16. The device of claim 10 wherein said sources of UV light form part of a rear-view mirror assembly of said vehicle.

17. The device of claim 10 wherein said sources of UV light are integrated into a dashboard of said vehicle.

18. The device of claim 10 wherein said sources of UV light emit UV light with a multitude of wavelengths.

19. The device of claim 10 wherein said device contains means for aiming said sources of UV light at said photochromic materials.

20. The device of claim 10 wherein said device contains a photosensor for adjustment of said UV light intensity in response to ambient light conditions, whereby said device causes said photochromic materials to react automatically in response to changing ambient light conditions.
